(19) United States
(12) Patent Application Publication
(10) Pub. No.: US 2024/0220488 A1
(43) Pub. Date: Jul. 4, 2024

(54) OPTIMIZING STRUCTURED QUERY LANGUAGE QUERIES USING CANDIDATE SETS

(71) Applicant: International Business Machines Corporation, Armonk, NY (US)

(72) Inventors: Rajesh Bordawekar, Westchester, NY (US); Jose Luis Pontes Correia Neves, Poughkeepsie, NY (US); Apoorva Nitsure, Pittsburgh, PA (US)

(21) Appl. No.: 18/092,045

(22) Filed: Dec. 30, 2022

(51) Int. Cl. G06F 16/242; G06F 16/22; G06F 16/2453

(52) U.S. Cl. CPC G06F 16/243; G06F 16/221; G06F 16/24542

(57) ABSTRACT

A count of unique values in a column of a database table is determined. A query on the database table is performed, wherein a technique for performing the query is selected based on the count of unique values.

### BACKGROUND

The present invention relates generally to the electrical, electronic and computer arts and, more particularly, to database systems.

State-of-the-art databases significantly enhance data insights by processing existing databases using a seamless infusion of artificial intelligence (AI) into the database system. Neural network training and inferencing integrated into a database infrastructure near the data source enable AI-enhanced, semantic queries that capture hidden relationships and hidden semantic information, using standard structured query language (SQL) interfaces. In some conventional systems, an unsupervised vector embedding approach is used to create the neural network models. Semantic models capture relationships between different types of relational entities (such as text, numeric values, images, and the like) and enables SQL-based information retrieval based on semantic contexts, rather than just entity values. For example, semantic representations of words may be generated using vectors and semantic similarities between the words may be measured based on the cosine distance calculation between the vectors. Some semantic models infer semantic meanings of database entities based on their neighboring entities (e.g., within a table row, across table rows, and the like).

### BRIEF SUMMARY

Principles of the invention provide techniques for optimizing SQL queries using candidate sets. In one aspect, an exemplary method includes the operations of determining a count of unique values in a column of a database table and performing a query on the database table, wherein a technique for performing the query is selected based on the count of unique values.

In one aspect, a non-transitory computer readable medium comprises computer executable instructions which when executed by a computer cause the computer to perform the method of determining a count of unique values in a column of a database table and performing a query on the database table, wherein a technique for performing the query is selected based on the count of unique values.

In one aspect, an apparatus comprises a memory and at least one processor, coupled to the memory, and operative to perform operations comprising determining a count of unique values in a column of a database table and performing a query on the database table, wherein a technique for performing the query is selected based on the count of unique values.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improve the technological process of computerized information retrieval from a database by reducing processing time, power, and/or memory;
improved performance for executing semantic-base SQL queries;
faster query processing time and a corresponding reduction in power;
reduced memory requirements as a result of reducing the number of rows of a database table to be processed during a query;
improved database system generates candidate sets of rows for query processing, eliminating the need to process every row of the table; and
improved performance of query processing by reusing similarity calculations for duplicate values of table entries.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates an end-to-end execution flow of an AI-powered relational database, in accordance with an example embodiment;

FIGS. 2A and 2B illustrate the textification of entries of a relational table, in accordance with an example embodiment;

FIG. 3A shows rows from an example database table, in accordance with an example embodiment;

FIG. 3B is a flowchart for an example method for performing clustering, in accordance with an example embodiment;

FIG. 3C is a flowchart for a first example method for optimizing a semantic query, in accordance with an example embodiment

FIG. 4 is a flowchart for a second example method for optimizing a semantic query, in accordance with an example embodiment;

FIG. 5 is a flowchart for a third example method for optimizing a semantic query, in accordance with an example embodiment; and

FIG. 6 depicts a computing environment according to an embodiment of the present invention.

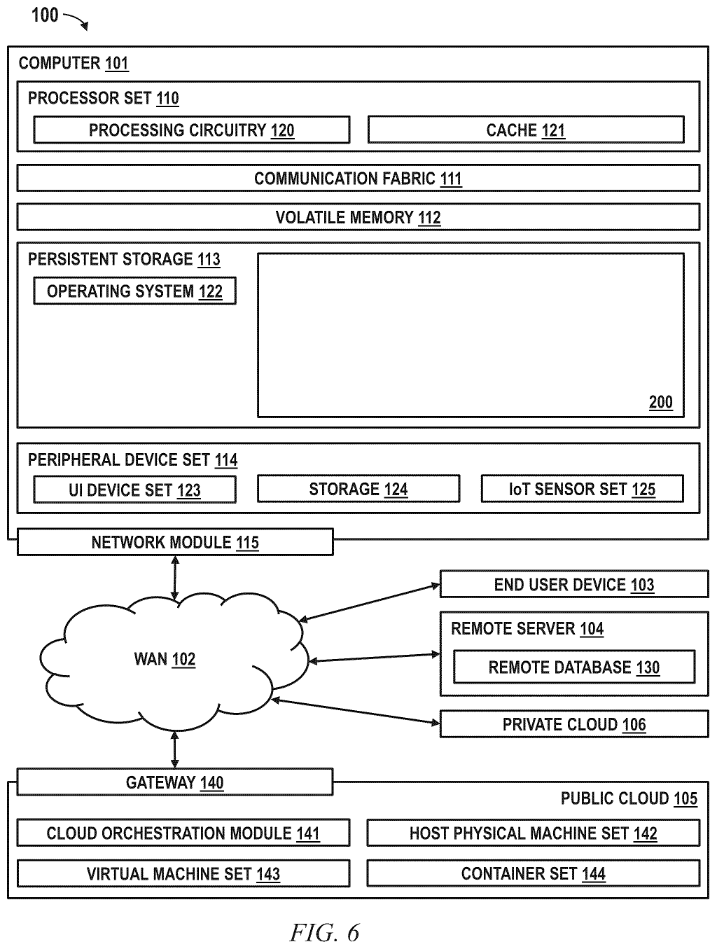

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Generally, techniques for efficiently employing cognitive intelligence (CI) queries are disclosed. In one or more embodiments, vector embedding techniques are applied on an unstructured view of a database and a vector model is built that captures latent semantic context of different types of database entities. The vector model is then seamlessly integrated into the SQL infrastructure and exposed to users via a class of SQL-based analytics queries known as cognitive intelligence (CI) queries. Traditional SQL queries rely mainly on value-based predicates to detect patterns, while CI queries also rely on semantic context. In one or more embodiments, for each database token, the model includes a vector that encodes contextual semantic relationships.

### Cognitive Intelligence Queries

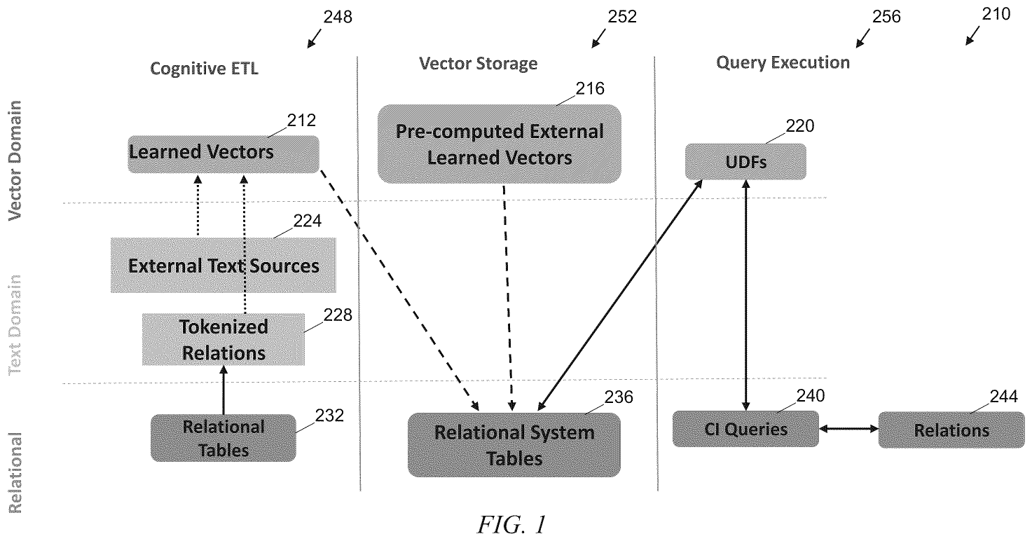

FIG. 1 illustrates an end-to-end execution flow 210 of an AI-powered relational database, in accordance with an example embodiment. CI queries 240 (also referred to as query 240 herein) use the model vectors 212, 216 to enable complex queries 240, such as semantic matching, inductive reasoning queries (such as analogies or semantic clustering), and predictive queries using entities not present in a database. The exemplary training approach has two unique aspects: (1) using a meaningful unstructured text representation of the structured relational data as input to the training process (i.e., irrespective of the associated SQL types, all entries from a relational database are converted to text tokens representing them), and (2) using the unsupervised vector embedding technique to generate meaning vectors 212 from the input text corpus. In one example embodiment, each vector 212 is a multi-dimensional unique numeric representation (320 numbers in one example case) of a given text corpus and each text corpus can be derived from different data types, prior to training. (After training, there is a one-to-one equivalency between each text corpus and a vector 212.) In one or more embodiments, every unique token from the input corpus is associated with a meaning vector 212. A vector storage phase 252 manages which vector models are used during the query execution phase 256 which can include the use of models trained from user specified tables or models trained from external sources 224.

For externally trained models, in one or more embodiments, the meaning of the tokens 228 embedded in each vector 212 are learned from external sources 224 and not from specific user selected tables. (Note that the tokens must typically be the same as the ones used in the query 240.) Query execution phase 256 allows user-issued SQL statements to extract information from one or more databases 236 and, in the process, the trained model is used within specific SQL statements. This can be seen as an inference step where the neural network model (vectors) is used in SQL through the use of User Defined Functions (UDFs) 220 to drive a SQL query with the learned information contained in the model.

A data preparation stage takes a relational table 232 (also referred to as database table 232 herein) with different SQL types as input and returns an unstructured but meaningful text corpus including a set of sentences, each sentence representing a row from the relational table. This transformation enables the generation of a uniform semantic representation of different data types. This process of “textification” typically requires two stages: data pre-processing and text conversion.

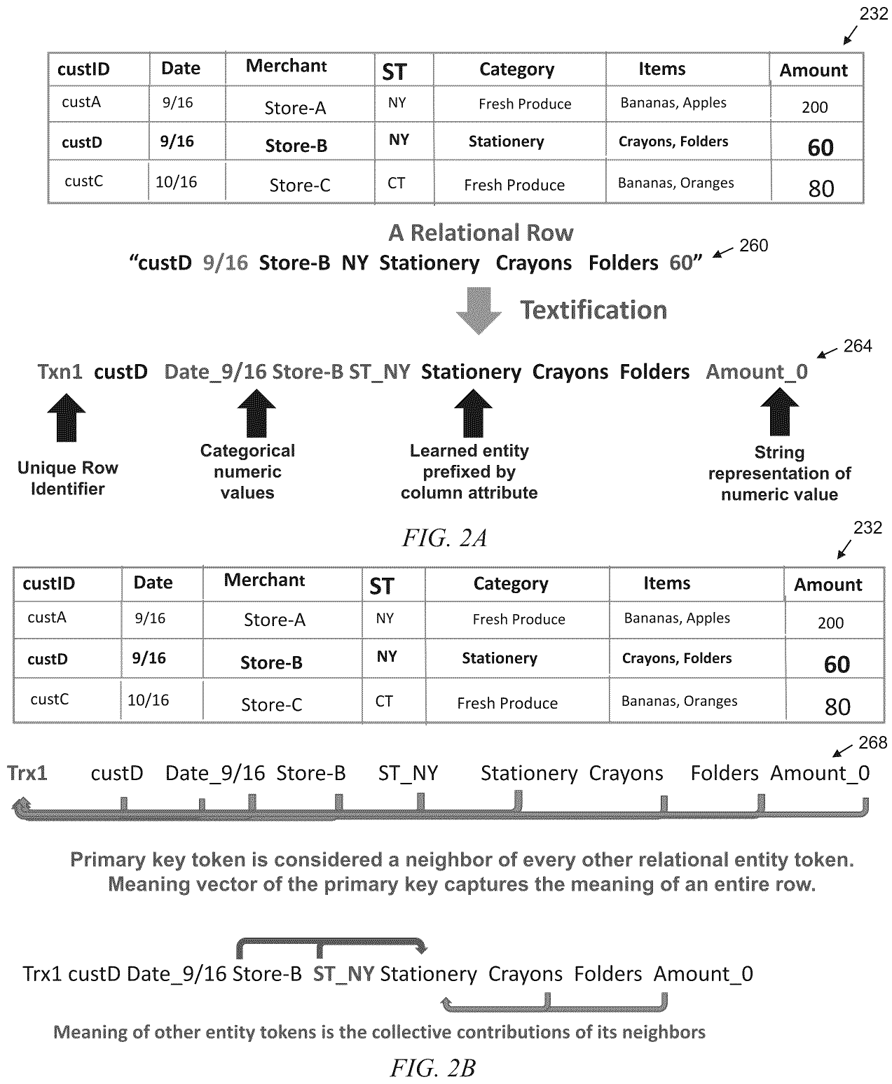

FIGS. 2A and 2B illustrate the textification of entries of a relational table 232, in accordance with an example embodiment. The textification phase processes each relational row separately and converts data of different data types to text. In some scenarios, it may be desirable to build a model that also captures relational column names. In one or more embodiments, for such cases, the pre-processing stage first processes the column names before processing the corresponding data.

For SQL variables of VARCHAR type, preprocessing involves one or more of the following actions: (1) prepend the column attribute string to a SQL variable, (2) create a single concept token from a group of VARCHAR tokens, e.g., Acme Bank is represented as Acme Bank, (3) create a single token for semantically similar sequences of VARCHAR tokens, e.g., two sequences of tokens, acme bank and ACME BANK, can be represented by a single compound token ACME BANK, and (4) use an external mapping or domain-specific ontologies to create a common representative token for a group of different input tokens.

For numeric values, three different approaches are used, for example, to generate equivalent text representations:
(1) creating a string version of the numerical value (e.g., value 100.0 for the column name AMOUNT can be represented by either AMOUNT 100.0 or “100.0”),
(2) user-managed categorization: a user can specify rules to define ranges for the numeric values and use them to generate string tokens for the numeric values (for example, consider values for a column name, Cocoa Contents. The value 80% can be replaced by the string token choc dark, while the value 35% can be replaced by the string token choc med, and the like), and
(3) user-directed clustering: a user can choose values of one or more numerical columns and cluster them using traditional clustering algorithms such as k-means or base-10 clustering (each numeric value is then replaced by a string representing the cluster identifier (ID) in which that value lies).

For image data, approaches similar to the ones used for numerical values are implemented.

Once text, numeric values and images are replaced by their text representations, a relational table can be viewed as an unstructured meaningful text corpus and can be used for building a vector embedding model. In one or more embodiments, null values of these types are replaced by the string column name Null. (The training algorithm provides special treatment for the entities corresponding to the SQL NULL (or equivalent) values. The NULL values are processed such that they do not contribute to the meaning of neighboring non-null entities; thus, eliminating their contribution to the embedded model which may lead to false semantic relationships.) Exemplary techniques can be applied to other data types such as SQL Date and spatial data types, such as latitude and longitude.

FIG. 2A illustrates entries of a relational table 232. The entries 260 of the second relational row are “textified” to textification 264. Textification 264 includes a unique row identifier TXn1, categorical numeric values (such as Date_9/16), a learned entity prefixed by the column attribute, and a string representation of a numeric value (the actual numeric value represented by the cluster ID after a clustering step, for example Amount_0). FIG. 2B illustrates the vector 268 corresponding to the textification 264. The primary key token is considered a neighbor to every other relational entity token in the row; the meaning vector 268 of the primary key captures the meaning of an entire row. The meaning of other entity tokens in the row is the collective contributions of their neighbors.

It is noted that every token in a sentence typically has equal influence on all other tokens in that sentence, irrespective of their positions; that is, a sentence generated from a relational table 232 is viewed as a bag of words, rather than an ordered sequence. In one example embodiment, a round-robin context is implemented; that is, the last word, Amount_0 has Trx1 and Folders as neighbors, as illustrated in FIG. 2B. In addition, by default, in one or more embodiments, every token, irrespective of its frequency, is assigned a vector 268. As noted above, for a unique primary key (with singular occurrence), its meaning vector 268 represents the meaning of the entire row. For example, token Txn1 may get a vector [0.123 0.923 0.056 . . . 0.005] (The size of the vector or number of elements is 320). This vector, [0.123 0.923 0.056 . . . 0.005], represents the meaning of Txn1 for the entire row. Another token in the row, for example Stationary, will be modeled by a different vector [0.675 0.821 0.042 . . . 0.999]. The vector for Stationary represents the meaning of Stationary with respect to its neighbors. Note that if Stationary appears in other rows, the neighbors in such rows will contribute to the vector, thereby changing the values above. At the end of training, there is only one vector for Txn1 and one vector for Stationary.

### Query Execution

Following vector training, the resultant vectors 212 are stored in a relational system table 236 (phase 2). At runtime, the SQL query execution engine uses various user-defined functions (UDFs) 220 that fetch the trained vectors 212 from the system table as needed and answer CI queries 240 (phase 3). The UDFs 220 take typed relational values as input and compute semantic relationships between them using uniformly untyped meaning vectors 212. This enables the relational database system to seamlessly analyze data of different types (such as text, numeric values, and images) using the same SQL CI query 240.

Each CI query 240 uses the UDFs 220 to execute nearest neighbor computations using the vectors 212 from the current word-embedding model. Thus, CI queries 240 provide approximate answers that reflect a given model. (Relations 244 are the semantic relations implemented by the CI queries 240, such as similarity, reasoning, predictive, and the like.)

For example, the following query 240 would find similar entities (VENDOR_NAME) to a given entity (Vendor) based on transaction behavior similarities:

SELECT V.VENDOR_NAME,
ProximityVendNameUDF(V.VENDOR_NAME, ‘Vendor’)
AS proximityValue
FROM Vendor_view V
WHERE ProximityVendNameUDF(V.VENDOR_NAME, ‘Vendor’)
ORDER BY proximityValue DESC

For each input variable, vectors 212 are fetched from the embedding model and a semantic similarity between vectors 212 is computed using cosine similarity: this varies between 1.0 and −1.0, with the closest being 1.0 and the furthest being −1.0.

In another example, the same meaning can be assigned to two customers based on the customers having the same or similar shopping list. As noted elsewhere herein, the content does not need to match exactly to have a match of semantic meaning.

The SQL semantic queries 240 provide capabilities including:
semantic similarity/dissimilarities;
grouping semantically-related entities;
semantic OLAP (online analytical processing);
reasoning; and
predictive queries.

One or more exemplary embodiments provide techniques for efficiently executing SQL semantic queries 240; particularly, in systems that may be processing- and/or memory-bound. For many applications, such as commercial applications, very large relational tables 232 are commonplace (such as tables 232 with billions of rows) and the processing of semantic applications on such tables 232 is typically at least memory-bound. As described above, SQL semantic queries 240 of the similarity type (similarity, dissimilarity, and semantic clustering) compute the operation on a row-by-row basis. This is accomplished, for example, by computing the cosine distance between two vectors 212, each representing one or more entries in a relational table 232. In one example embodiment, the vectors 212 are normalized during training to transform the cosine distance calculation into a simple dot product calculation between two vectors 212, thus improving the speed of performing the SQL query. In one example embodiment, vector normalization is performed using a conventional technique and is a transformation performed on a multi-dimensional vector that reduces the length of a vector to unity while preserving its direction. The purpose of normalizing vectors after training a model and prior to using them in CI queries is that it simplifies the calculation of the cosine distance between vectors, dramatically improving the runtime.

The data in a database is generally represented with multi-dimensional vectors 212 obtained through the described vector embedding technique. A user typically performs a myriad of semantic operations on the database on a row-by-row basis. Although these are sufficient to provide the mathematical support for SQL semantic queries 240, they are not the most efficient way to obtain such information. Several deficiencies are identified.

First, the mathematical operations are typically limited to vector operations. They do not explore the matrix inherent feature of semantic operations. For example, a similarity query on a row is implemented with a dot product calculation between two vectors 212: the predicate passed in the query 240 and the column value for each row in the relational table 232. If the similarity query pulls up several vectors 212 at once (creating a matrix), all the similarity calculations can be performed with a single call to a matrix-vector multiplication. Likewise, if the SQL semantic query 240 implements analogy type functions where the predicate is composed of three user selected vectors 212, a single call to a matrix-matrix multiplication is significantly faster than implementing such operation vector by vector. For an analogy query, the first matrix includes the multiple vectors obtained from a given column and the second matrix includes the three user-supplied vectors as predicates.

Second, the implementation of the query 240 as a matrix-vector multiplication or matrix-matrix multiplication may still be very inefficient in terms of processing and memory, as they may lead to very high levels of repeated calculations and unnecessary use of memory. For example, considering a relational table 232 with one million (M) rows (small in today's real applications), a query 240 on a column with only 100,000 unique values will lead to 900,000 unnecessary computations. Furthermore, there is a waste of memory to store the 900,000 repeated values. (Note that this memory is only needed to perform the calculations.) If the operations were to be computed at the beginning of processing the SQL query 240 using matrix-vector multiplication and/or matrix-matrix multiplication, the memory could be freed up for other purposes.

It is also important to mention that a given semantic query 240 applies to a column in the relational table 232 and, as such, only the embedding vectors 212 generated for that column are relevant for the calculations. As such, the vector embedding models generated by model training can be grouped by column with the additional benefit of providing relevant information for each column. Furthermore, if a column is frequently used in SQL semantic queries 240 and the number of unique vectors 212 is small, all the possible cosine distances can be pre-calculated upfront using matrix-matrix multiplication and the calculations accessed when processing the SQL query 240. The maximum memory needed is two times the number of column values times the vector size (320 numbers, each number represented using the Institute of Electrical and Electronics Engineers (IEEE) standard 754 floating point number format in single precision (32-bit=4 bytes). Although other precisions are available, such as double precision (64-bit=8 bytes) or half precision (16-bit=2 bytes), the semantic relationships are equally applicable). The CPU runtime is N²/2 where N is the number of column values.

Third, there are scenarios where a column may have a very large number of unique values. Assume, for example, the reverse of the previous scenario is true: for a 1 million row table, 900,000 are unique values and only 100,000 are repeated. Assuming that the size of an embedding vector is on the order of 320 floating-point numbers, the memory footprint of a single vector is Mv=320×4 Bytes=1.28 kilobytes (KB). If there are 100,000 unique values, 100 k×1.28 k=128 megabits (Mb) of memory is needed to store such a matrix. If the number of unique elements raises to 900,000, the memory raises to 1.152 gigabits (Gb). Although these may not seem to be large numbers, it is important to note that it is not uncommon for practical tables to have a billion or more rows. In other words, the values above will grow by three orders of magnitude.

Since processing multi-billion row tables is at least a memory-limited problem, new approaches beyond the matrix-vector multiplication and matrix-matrix multiplication need to be developed. Such techniques are introduced below. Several techniques that leverage the application of clustering techniques of the embedding vectors are disclosed herein. In one aspect, at the end of model training (when all the vectors 212 are created), the columns that contain a very large number of unique vectors 212 are identified. For such columns, a multi-dimensional clustering technique is used (for example, k-means clustering) and each vector embedding is assigned to the cluster it is most closely related to. Since clustering groups vector embeddings that are close to each other, during SQL query processing, only the members (rows) of the cluster that is associated with the predicate are selected and the matrix-vector multiplication or matrix-matrix multiplication operations are performed to derive the answers to the query 240.

In another approach, the calculation is extended beyond one cluster to the members of two or more clusters that are the closest to the cluster associated with the predicate. To accomplish this, the centroid of the cluster associated with the predicate is selected. Then, the cosine distance between this centroid and the centroids of all the other clusters are calculated. The clusters with the closest distance are selected and a matrix with all the elements of such clusters is created. Note that the number of clusters is much smaller than the number of vector embeddings associated with a column. For example, for the scenario above where a column may have one million unique values, such vectors could be clustered with k-means clustering and 250 clusters would be generated. Since one objective of clustering is to equally balance all the vectors amongst clusters, it is not unrealistic to assume that each cluster will have around the same order of members. Without loss of generality, assume that the 1 million (M) vectors are equally divided across all 250 clusters, or the number of elements per cluster is 1M/250=4,000 elements. In practice, there is always an imbalance of the number of vectors, but those discrepancies will not diminish the value of the technique. As such, a semantic SQL query 240 that uses this technique performs matrix-vector multiplication or matrix-matrix multiplication on a minimum of 4,000 vectors to multiples of 4,000. Note that the number of clusters can be pre-calculated to create clusters with a reasonable number of vectors 212 that still preserve the accuracy of the query 240 as compared to an implementation that includes all the vectors 212.

### Semantic Similarity Calculation Reuse

Consider a table with 1.3 million (M) rows and 80,000 unique vendors (as identified by a VENDOR column of the table 232). To process a query 240 searching for vendors with a name similar to a given vendor (as identified in the SQL query 240), 1.3 M rows would need to be processed. To improve the processing speed and reduce the amount of memory required for the query 240, the number of unique values in a column (such as 80,000 for vendor names) is determined. The similarity is then measured once for each unique vendor name and the calculated similarity measure is reused when a row containing the same vendor name is encountered.

### Semantic Batching

For columns that include a large number of unique values, as described elsewhere herein, the rows are clustered together based on the vectors 212 produced for each row by the neural network, where each cluster is characterized by the centroid of the cluster. That is, look for similarity between rows that match in one aspect, such as purchased produce or transactions with Acme Bank, which form a candidate set. For example, the column of the primary key, which is unique for each row, may be selected for clustering. A SQL query 240 can then be performed by processing only the rows of the cluster which is closest to the predicate of the query 240. For example, a lookup based on the predicate of the SQL query 240 may be performed to obtain the vector 212 that corresponds to the predicate, and the cluster having a centroid closest to the vector 212 of the predicate is identified for processing.

The SQL query 240 can also be performed by processing only the rows of a proper subset of the clusters. The clusters may be chosen by selecting the cluster(s) whose centroid(s) are closest to the predicate of the query 240.

In one example embodiment, rows may be processed in batches. For example, the 80,000 rows of unique vendors may be divided into eight sets of 10,000 rows each, and the sets can be processed one at a time. This approach would require eight calls to matrix-vector multiplication or matrix-matrix multiplication, but the memory needed to represent the matrix is only ⅛^{th} of the memory required to represent the full matrix. Since the matrix-vector multiplication or matrix-matrix multiplication step is only a fraction of processing a SQL query, one can trade-off runtime for less memory consumption, particularly when tables 232 grow by multiple orders of magnitude.

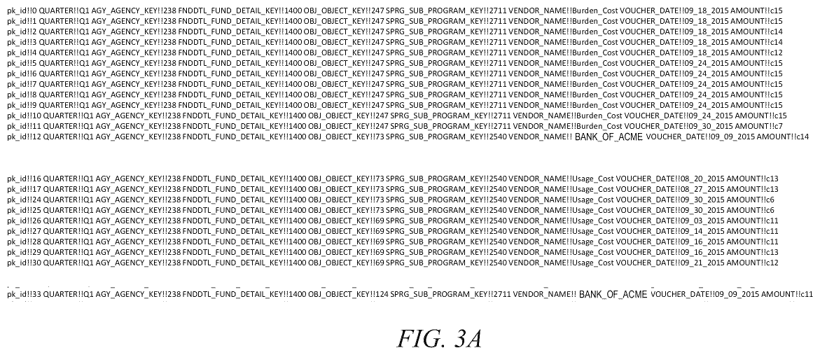

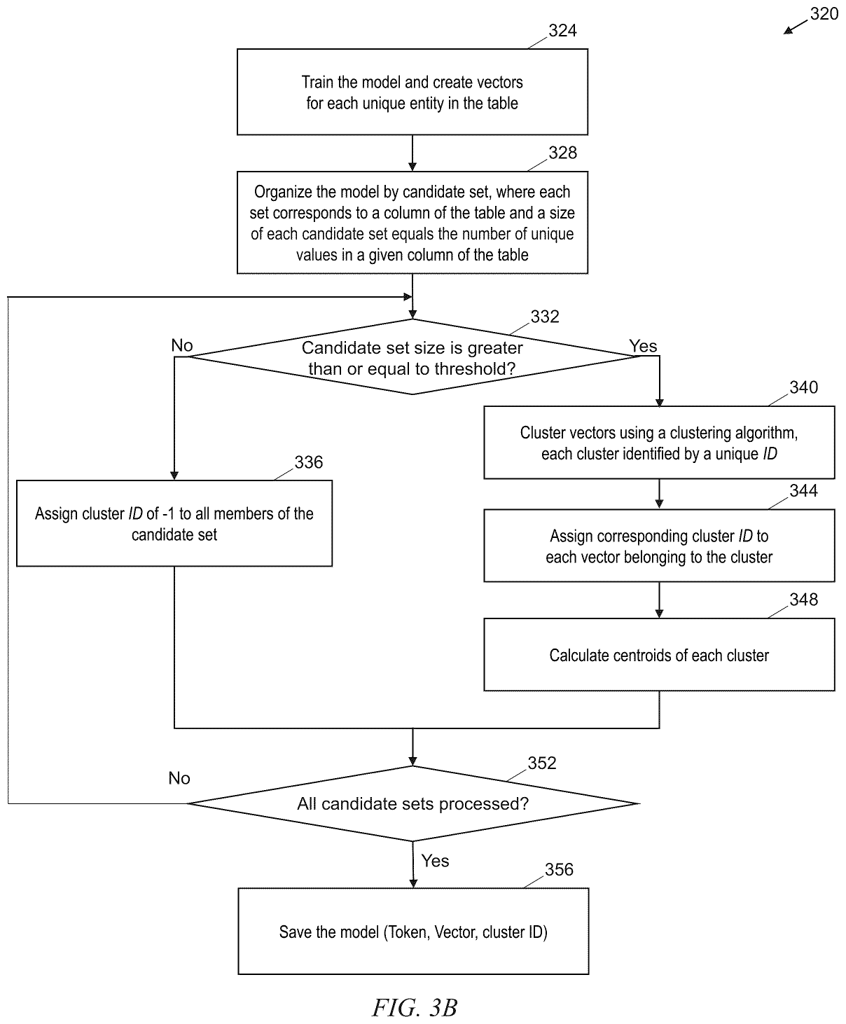

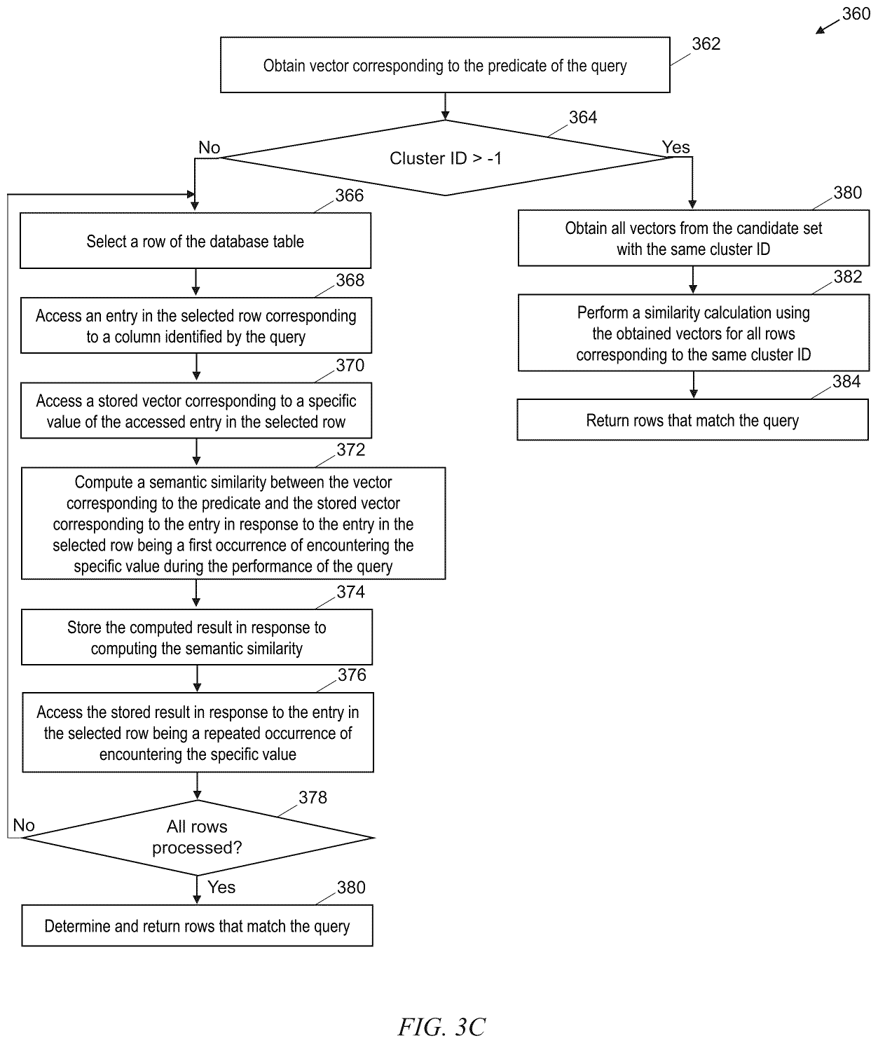

FIG. 3A shows rows from an example database table 232, in accordance with an example embodiment. For example, consider the following SQL query 240:

SELECT AI_SIMILARITY(X.VENDOR_NAME,’
Burden_Cost’ USING MODEL COLUMN VENDOR_NAME) AS SimilarityScore, X.*
FROM CHURN X
WHERE X.VENDOR_NAME <> ‘Burden_Cost’
ORDER BY Similarity Score DSC
FETCH FIRST 5 ROWS ONLY;

### Batching in Semantic Function Execution

As noted above, conventional approaches invoke the AI_SIMILARITY function for every row in the database table 232, thus performing O(rows) computations. This results in multiple per-row tiny dot-products that are difficult to accelerate and operate on semantically irrelevant data for the query 240.

### Naïve Batching in Semantic Function Execution

In one example embodiment, the type-based collation of vector records in the stored model is exploited. At the first invocation of the semantic function, the vector computation is performed on a set of vectors 212 generated from a batch of tokens of the same type (e.g., VENDOR_NAME). The resulting computation is O(number of tokens) rather than O(rows). For example, 80,000 vs 1.3 million computations.

For the computation of future rows, the result values from the computed result vector are maintained and are fetched based on the entry of the relevant column, thereby avoiding fetching the vectors 212 from the model table and invoking the similarity computation again. This results in a coarser-grained computation, suitable for acceleration, but can still result in irrelevant computations. Also, the batch size may be larger and may require partitioning.

### Candidate Set Clustering for Sematic Function Execution

FIG. 3B is a flowchart for an example method 320 for performing clustering, in accordance with an example embodiment. Clustering is performed as an additional step added to the training phase of creating the model. The model is organized as a group of candidate sets. Each candidate set contains all the unique tokens associated with a given table column. For example, the column VENDOR from the table represented in FIG. 3A is a candidate set with more than 80K unique values (Burden_Cost being one such value). In one example embodiment, a candidate set is obtained and, if the size of the set is greater than a predefined threshold, the candidates are clustered into a predefined number of clusters (the threshold and the number of clusters per candidate set are pre-defined parameters). After clustering the candidate set, the cluster ID is added to each (token, vector) pair and the centroid vector of each cluster is calculated. If the candidate set is less than the threshold, the clustering of that set is skipped and the model is saved by candidate set, each including the number of clusters (0 if clustering is not performed), the vector centroid of a cluster and all the 3-tuples of token, vector, and cluster ID. It is noted that, in one example embodiment, k-means is used for creating n pre-defined clusters.

Returning to FIG. 3B, in one example embodiment, a model is trained and vectors are created for each unique entity in the database table 232 (operation 324). The model is organized by candidate set, where each set corresponds to a column of the table 232 and a size of each candidate set equals the number of unique values in a given column of the table 232 (operation 328). A check is performed to determine if the size of a selected candidate set is greater than or equal to a predefined threshold (decision block 332). If the size of the selected candidate set is not greater than or equal to a predefined threshold (NO branch of decision block 332), a cluster ID of −1 is assigned to all members of the selected candidate set (operation 336). (The skilled artisan would recognize that the value of the threshold may be determined heuristically. For example, an initial threshold of 100,000 may be selected. The threshold may be changed over time by monitoring the performance of the system (in terms of memory usage, processing time, and the like) and adjusting the threshold to optimize the performance), and based on the available computing power as described below. Clustering parameters, such as the number of unique elements to cluster and the number of clusters may change over time based on monitoring performance (in terms of memory usage, processing time, and the like) and quality of results (results of a SQL query with and without clustering). In one or more embodiments, the threshold is based on the performance of the computer; i.e., the higher the performance of the computer, the higher the threshold, such that clustering is invoked for higher performing computers. For example, if using a standard CPU, use a lower threshold, but if using a single instruction, multiple data (SIMD) unit or other high-powered unit, use a higher threshold. This is because the cost of invoking the accelerator is not justified by the performance gain of clustering.

If the size of the selected candidate set is greater than or equal to the predefined threshold (YES branch of decision block 332), the vectors of the candidate set are clustered using a clustering algorithm, where each cluster is identified by a unique ID (operation 340). A corresponding cluster ID is assigned to each vector belonging to the cluster (operation 344) and the centroids of each cluster are calculated (operation 348).

A check is performed to determine if all candidate sets have been processed (decision block 352). If all candidate sets have not been processed (NO branch of decision block 352), the method 320 proceeds with operation 332; otherwise, (YES branch of decision block 352), the model is saved (operation 356).

### Intelligent Batching: Candidate Sets-Based Execution

In one example embodiment, computations are performed on only relevant items, that is, a number of items smaller than the number of tokens. As noted above, this can be used to partition batches.

FIG. 3C is a flowchart for a first example method 360 for optimizing a semantic query 240, in accordance with an example embodiment. It is noted that the clustering is performed during the training phase, as described above in conjunction with FIG. 3B. During query execution, the clustering information is used to focus the calculation using the clustering data, if such clustering information exists.

In one example embodiment, query processing works as follows. The vector 212 associated with the predicate of the query 240 (including the corresponding cluster ID) are obtained in step 362. A cluster ID of −1 means no clustering information exists for the candidate set and the query execution proceeds as outlined in naïve batching description above (NO branch of decision block 364). If the cluster ID is greater than −1, all the vectors from the candidate set with the same cluster ID are obtained (via YES branch of decision block 364). These vectors are used to perform the similarity calculation. As the query processing proceeds through all the rows of the table 232, if the value in the table 232 does not contain the same cluster ID, the calculation returns −1 (indicating that the vectors are not similar); otherwise, the results of the similarity calculation are returned. A value of this approach is the reduced number of calculations. For example, if column VENDOR from the table in FIG. 3 with 80,000 unique values is clustered using 100 clusters, around 800 members per cluster would be derived in an ideal scenario. While the naïve approach would have to compute 800,000 similarities, this approach will only compute 800 similarities for the members with the same cluster ID.

In one example embodiment, a vector 212 associated with the predicate of the query 240 (including the corresponding cluster ID) is obtained (operation 362). A check is performed to determine if the cluster ID is greater than −1 (decision block 364). If the cluster ID is greater than −1 (YES branch of decision block 364), the method 360 proceeds with operation 380 and the clustering technique is utilized; otherwise, (NO branch of decision block 364), the method 360 proceeds with operation 366 and the calculation reuse technique is utilized.

Considering the YES branch of decision block 364 (when proceeding with operation 380), in one example embodiment, all the vectors 212 from the candidate set having the same cluster ID are obtained (operation 380). A similarity calculation is performed for each unique pair of the obtained vectors 212 and, as each row of the table 232 is accessed, the similarity results are utilized to determine if the accessed row is a match with the query 240 (that is, determining if the vector 212 associated with the row is similar to the vector 212 of the predicate of the query 240) (operation 382). For example, similarity calculations may be computed once for each pair of vectors in the cluster, and then the similarity results may be reutilized as each row in the table is processed. In one or more embodiments, calculations occur only once, and the results are used while the rows are processed by the SQL query. If a vector selected from a row is not in the cluster or clusters used during the calculation it means that the vector is not similar enough to any of the vectors in the cluster and a value of −1 is assigned to the similarity calculation. It is noted that operation 382 only needs to be performed for rows having a vector 212 that is a member of a cluster identified by the cluster ID utilized in operation 380. The rows of the table 232 that match the query 240 are returned (operation 384).

Considering the NO branch of decision block 364 (when proceeding with operation 366), in one example embodiment, a row of the relational table 232 is selected (operation 366) and an entry in the selected row corresponding to a column identified by the query 240 is accessed (operation 368). A stored vector 212 corresponding to a specific value of the accessed entry in the selected row is accessed (operation 370).

A semantic similarity between the vector 212 corresponding to the predicate and the stored vector 212 corresponding to the entry is computed in response to the entry in the selected row being a first occurrence of encountering the specific value during the performance of the query 240 (operation 372). If the entry in the selected row was a first occurrence of encountering the specific value during the performance of the query, the computed similarity result is stored for future use (or, in other words, the computed result is stored in response to computing the semantic similarity) (operation 374). If the entry in the selected row is a repeated occurrence of encountering the specific value, the stored similarity result is accessed (operation 376).

A check is performed to determine if all rows of the database table 232 have been processed (decision block 378). If all rows of the database table 232 have not been processed (NO branch of decision block 378), the method 360 proceeds with operation 366; otherwise (YES branch of decision block 378), the rows that match the query 240 are determined and returned (operation 380).

Another variation of the process described in FIG. 3C takes advantage of the cluster centroids computed during the training phase. This approach increases the number of calculations to account for the scenarios where there are clusters very similar to each other. This variation also starts with the vector 212 associated with the predicate. If the cluster ID equals −1, no clustering information exists for the candidate set and query execution proceeds as outlined in the naïve batching description above. If the cluster ID is greater than −1, the centroid associated with the cluster ID is compared to all the other centroids of the given candidate set. (Comparing means calculating the cosine distance between the cluster ID centroid and every other cluster centroid of the candidate set.) A pre-defined number of clusters with the highest cosine distance is chosen and all the members of these clusters are retrieved for batch calculation via the YES branch of decision block 364; that is, instead of considering vectors 212 of a single cluster, vectors 212 of a plurality of clusters may be utilized. The query processing then proceeds as described in FIG. 3C. For each row, if the value in the table 232 does not contain the same cluster ID) as any of the clusters most similar with the cluster ID (highest cosine distance) of the predicate, the calculation returns −1 (indicating that the vectors 212 are not similar). Otherwise, the calculation retrieves the value from the batch calculation of the vector predicate and all the vector members of the clusters with the highest cosine distance with cluster ID. Referring to the example above, assume that the three clusters with the highest cosine distance are chosen. This means that the number of calculations increases to 2,300, but it is still much less than 80,000. It is noted that the skilled artisan would be familiar with heuristically determining a distance threshold for identifying the most similar clusters.

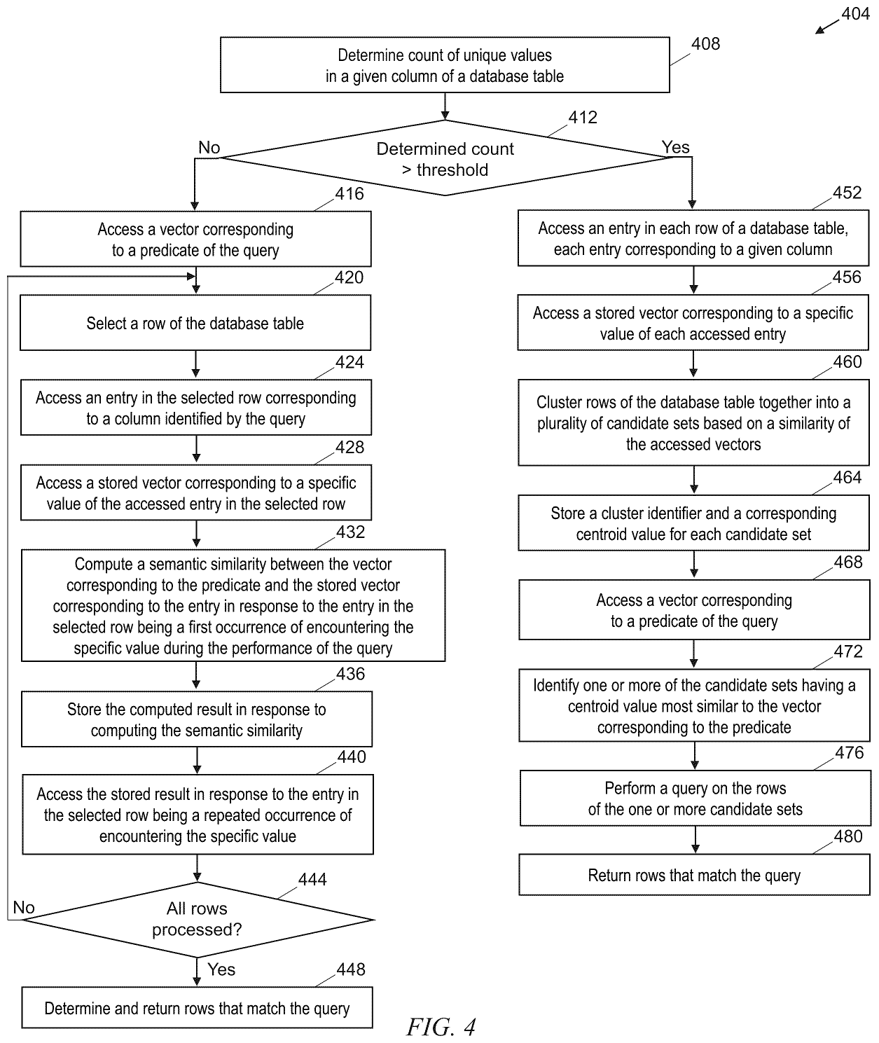

FIG. 4 is a flowchart for a second example method 404 for optimizing a semantic query 240, in accordance with an example embodiment. In one example embodiment, a count of unique values in a given column of a database table 232 is determined (operation 408). A check is performed to determine if the determined count is greater than a threshold (decision block 412). (As described above, the skilled artisan would recognize that the value of the threshold may be determined heuristically.) If the determined count is greater than the threshold (YES branch of decision block 412), the method 404 proceeds with operation 452 and the clustering technique is performed; otherwise, (NO branch of decision block 412), the method 404 proceeds with operation 416 and the calculation reuse technique is performed.

Considering the branch when proceeding with operation 416, in one example embodiment, a vector 212 corresponding to a predicate of the query 240 is accessed (operation 416). A row of the relational table 232 is selected (operation 420) and an entry in the selected row corresponding to a column identified by the query 240 is accessed (operation 424). A stored vector 212 corresponding to a specific value of the accessed entry in the selected row is accessed (operation 428).

A semantic similarity between the vector 212 corresponding to the predicate and the stored vector 212 corresponding to the entry is computed in response to the entry in the selected row being a first occurrence of encountering the specific value during the performance of the query 240 (operation 432). The computed result is stored in response to computing the semantic similarity (operation 436). The stored result is accessed in response to the entry in the selected row being a repeated occurrence of encountering the specific value (operation 440).

A check is performed to determine if all rows of the database table 232 have been processed (decision block 444). If all rows of the database table 232 have not been processed (NO branch of decision block 444), the method 404 proceeds with operation 420; otherwise (YES branch of decision block 444), the rows that match the query 240 are determined and returned (operation 448).

Considering the branch when proceeding with operation 452, in one example embodiment, an entry in each row of a database table 232 is accessed, where each entry corresponds to a given column (operation 452). A stored vector corresponding to the specific value of each accessed entry is accessed (operation 456) and the rows of the database table 232 are clustered together into a plurality of candidate sets based on a similarity of the accessed vectors 212 (operation 460). A cluster identifier and a corresponding centroid value are stored for each candidate set (operation 464) and a vector 212 corresponding to a predicate of the query 240 is accessed (operation 468). One or more of the candidate sets having a centroid value most similar to the vector 212 corresponding to the predicate are identified (operation 472) and a query 240 on the rows of the one or more candidate sets is performed (operation 476). The rows that match the query 240 are returned (operation 480).

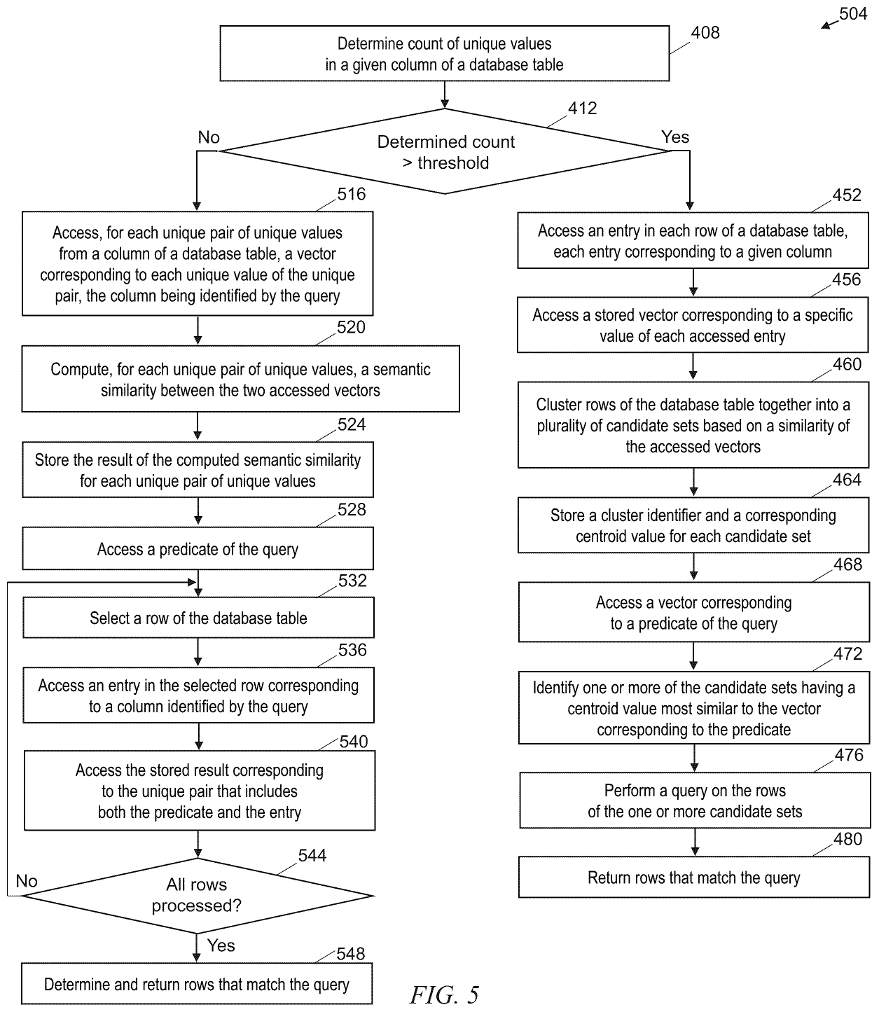

FIG. 5 is a flowchart for a third example method 504 for optimizing a semantic query 240, in accordance with an example embodiment. Operations 408-412 and 452-480 are the same as the corresponding operation of the method 404. The operations of the calculation reuse technique for method 504 are performed as follows.

In one example embodiment, following the “NO” branch of decision block 412, for each unique pair of unique values from a column of a database table 232, a vector 212 corresponding to each unique value of the unique pair to a predicate of the query 240 is accessed, the column being identified by the query (operation 516). A semantic similarity between the two accessed vectors 212 is computed for each unique pair of unique values (operation 520) and the result of the computed semantic similarity for each unique pair of unique values is stored (operation 524). A predicate of the query 240 is accessed (operation 528), a row of the relational table 232 is selected (operation 532) and an entry in the selected row corresponding to a column identified by the query 240 is accessed (operation 536). The stored result corresponding to the unique pair that includes both the predicate and the entry is accessed (operation 540).

A check is performed to determine if all rows of the database table 232 have been processed (decision block 544). If all rows of the database table 232 have not been processed (NO branch of decision block 544), the method 504 proceeds with operation 532; otherwise, (YES branch of decision block 544), the rows that match the query 240 are determined and returned (operation 548).

Given the discussion thus far, it will be appreciated that, in general terms, an exemplary method, according to an aspect of the invention, includes the operations of determining a count of unique values in a column of a database table 232 (operation 408) and performing a query 240 on the database table 232, wherein a technique for performing the query 240 is selected based on the count of unique values (operations 416-480).

In one example embodiment, a method to optimize SQL queries using candidate sets includes the operations of identifying a candidate set of data from within a whole set of data and performing one or more similarity queries on the candidate set of data.

In one example embodiment, the performing the query 240 further comprises determining the technique by comparing the count of unique values to a given threshold (operation 412).

In one example embodiment, the performing the query 240 further comprises accessing a vector 212 corresponding to a predicate of the query 240 (operation 416); selecting a row of the database table 232 (operation 420); accessing an entry in the selected row, the entry corresponding to a column identified by the query 240 (operation 424); accessing a stored vector 212 corresponding to a specific value of the accessed entry in the selected row (operation 428); computing, using cosine similarity, a semantic similarity between the vector 212 corresponding to the predicate of the query 240 and the stored vector 212 corresponding to the entry in the selected row in response to the entry in the selected row being a first occurrence of encountering the specific value during the performance of the query (operation 432); and storing a result of the computed semantic similarity in response to computing the semantic similarity (operation 436).

In one example embodiment, the stored result is accessed in response to the entry in the selected row being a repeated occurrence of encountering the specific value during the performance of the query 240 (operation 440).

In one example embodiment, the result varies between 1.0 and −1.0, with 1.0 representing a greatest similarity and −1.0 representing a smallest similarity.

In one example embodiment, a plurality of semantic similarities are pre-calculated by accessing, for each unique pair of unique values from a column of the database table 232, a vector 212 corresponding to each unique value of the unique pair, the column being identified by the query 240 (operation 516); computing, for each unique pair of unique values, a semantic similarity between the two accessed vectors 212 (operation 520); and storing, for each unique pair of unique values, a result of the computed semantic similarity (operation 524).

In one example embodiment, a predicate of the query 240 is accessed (operation 528); a row of the database table 232 is selected (operation 532); an entry in the selected row is accessed, the entry corresponding to a column identified by the query 240 (operation 536); and the stored result corresponding to the unique pair that includes both the predicate and the entry is accessed (operation 540).

In one example embodiment, an entry in each row of the database table 232 is accessed, each entry corresponding to a given column (operation 452); a stored vector 212 corresponding to a specific value of each accessed entry is accessed (operation 456); rows of the database table 232 are clustered together into a plurality of candidate sets based on a semantic similarity of the accessed vectors 212 (operation 460); and a cluster identifier and a corresponding centroid value for each candidate set are stored (operation 464).

In one example embodiment, a vector 212 corresponding to a predicate of the query 240 is accessed (operation 468); one or more of the candidate sets having a centroid value most similar to the vector 212 corresponding to the predicate are identified (operation 472); and the performing of the query 240 on the database table 232 is performed on only rows of the database table 232 that are included in the one or more identified candidate sets (operation 476).

In one example embodiment, the clustering is k-means clustering.

In one example embodiment, the computation of the semantic similarity is implemented with a dot product calculation.

In one example embodiment, each unique entry in the database table 232 is converted to a corresponding vector 212 and each corresponding vector 212 is stored in a vector table indexed by a value of the unique entry.

In one example embodiment, the performing the query 240 further comprises processing rows of a candidate set in batches.

In one aspect, a non-transitory computer readable medium comprises computer executable instructions which when executed by a computer cause the computer to perform the method of determining a count of unique values in a column of a database table 232 (operation 408) and performing a query 240 on the database table 232, wherein a technique for performing the query 240 is selected based on the count of unique values (operations 416-480).

In one aspect, an apparatus comprises a memory and at least one processor, coupled to the memory, and operative to perform operations comprising determining a count of unique values in a column of a database table 232 (operation 408) and performing a query 240 on the database table 232, wherein a technique for performing the query 240 is selected based on the count of unique values (operations 416-480).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as semantic query mechanism 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining a count of unique values in a column of a database table; and
performing a query on the database table, wherein a technique for performing the query is selected based on the count of unique values.

2. The method of claim 1, wherein the performing the query further comprises determining the technique by comparing the count of unique values to a given threshold.

3. The method of claim 1, wherein the performing the query further comprises:
accessing a vector corresponding to a predicate of the query;
selecting a row of the database table;
accessing an entry in the selected row, the entry corresponding to a column identified by the query;
accessing a stored vector corresponding to a specific value of the accessed entry in the selected row;
computing, using cosine similarity, a semantic similarity between the vector corresponding to the predicate of the query and the stored vector corresponding to the entry in the selected row in response to the entry in the selected row being a first occurrence of encountering the specific value during the performance of the query; and
storing a result of the computed semantic similarity in response to computing the semantic similarity.

4. The method of claim 3, further comprising accessing the stored result in response to the entry in the selected row being a repeated occurrence of encountering the specific value during the performance of the query.

5. The method of claim 3, wherein the result varies between 1.0 and −1.0, with 1.0 representing a greatest similarity and −1.0 representing a smallest similarity.

6. The method of claim 1, further comprising pre-calculating a plurality of semantic similarities by:
accessing, for each unique pair of unique values from a column of the database table, a vector corresponding to each unique value of the unique pair, the column being identified by the query;
computing, for each unique pair of unique values, a semantic similarity between the two accessed vectors; and
storing, for each unique pair of unique values, a result of the computed semantic similarity.

7. The method of claim 6, further comprising:
accessing a predicate of the query;
selecting a row of the database table;
accessing an entry in the selected row, the entry corresponding to a column identified by the query; and
accessing the stored result corresponding to the unique pair that includes both the predicate and the entry.

8. The method of claim 1, further comprising:
accessing an entry in each row of the database table, each entry corresponding to a given column;
accessing a stored vector corresponding to a specific value of each accessed entry;
clustering rows of the database table together into a plurality of candidate sets based on a semantic similarity of the accessed vectors; and
storing a cluster identifier and a corresponding centroid value for each candidate set.

9. The method of claim 8, further comprising:
accessing a vector corresponding to a predicate of the query;
identifying one or more of the candidate sets having a centroid value most similar to the vector corresponding to the predicate; and
wherein the performing of the query on the database table is performed on only rows of the database table that are included in the one or more identified candidate sets.

10. The method of claim 8, wherein the clustering is k-means clustering.

11. The method of claim 1, wherein the computation of the semantic similarity is implemented with a dot product calculation.

12. The method of claim 1, further comprising:
converting each unique entry in the database table to a corresponding vector; and
storing each corresponding vector in a vector table indexed by a value of the unique entry.

13. The method of claim 1, wherein the performing the query further comprises processing rows of a candidate set in batches.

14. A non-transitory computer readable medium comprising computer executable instructions which when executed by a computer cause the computer to perform the method of:
determining a count of unique values in a column of a database table; and
performing a query on the database table, wherein a technique for performing the query is selected based on the count of unique values.

15. An apparatus comprising:
a memory; and
at least one processor, coupled to said memory, and operative to perform operations comprising:
determining a count of unique values in a column of a database table; and
performing a query on the database table, wherein a technique for performing the query is selected based on the count of unique values.

16. The apparatus of claim 15, wherein the performing the query further comprises:
accessing a vector corresponding to a predicate of the query;
selecting a row of the database table;
accessing an entry in the selected row, the entry corresponding to a column identified by the query;
accessing a stored vector corresponding to a specific value of the accessed entry in the selected row;
computing, using cosine similarity, a semantic similarity between the vector corresponding to the predicate of the query and the stored vector corresponding to the entry in the selected row in response to the entry in the selected row being a first occurrence of encountering the specific value during the performance of the query; and
storing a result of the computed semantic similarity in response to computing the semantic similarity.

17. The apparatus of claim 15, the operations further comprising pre-calculating a plurality of semantic similarities by:
accessing, for each unique pair of unique values from a column of the database table, a vector corresponding to each unique value of the unique pair, the column being identified by the query;
computing, for each unique pair of unique values, a semantic similarity between the two accessed vectors; and
storing, for each unique pair of unique values, a result of the computed semantic similarity.

18. The apparatus of claim 17, the operations further comprising:
accessing a predicate of the query;
selecting a row of the database table;
accessing an entry in the selected row, the entry corresponding to a column identified by the query; and
accessing the stored result corresponding to the unique pair that includes both the predicate and the entry.

19. The apparatus of claim 15, the operations further comprising:
accessing an entry in each row of the database table, each entry corresponding to a given column;
accessing a stored vector corresponding to a specific value of each accessed entry;
clustering rows of the database table together into a plurality of candidate sets based on a semantic similarity of the accessed vectors; and
storing a cluster identifier and a corresponding centroid value for each candidate set.

20. The apparatus of claim 19, the operations further comprising:
accessing a vector corresponding to a predicate of the query;
identifying one or more of the candidate sets having a centroid value most similar to the vector corresponding to the predicate; and
wherein the performing of the query on the database table is performed on only rows of the database table that are included in the one or more identified candidate sets.
